(19) United States
(12) Patent Application Publication
(10) Pub. No.: US 2014/0081800 A1
(43) Pub. Date: Mar. 20, 2014

(54) Recommending Product Information

(71) Applicant: Alibaba Group Holding Limited, Grand Cayman (KY)

(72) Inventors: Tong Liu, Hangzhou (CN); Bing Wang, Hangzhou (CN)

(73) Assignee: Alibaba Group Holding Limited, Grand Cayman (KY)

(21) Appl. No.: 14/028,279

(22) Filed: Sep. 16, 2013

(30) Foreign Application Priority Data
Sep. 17, 2012 (CN) 201210345774.9

(51) Int. Cl. G06Q 30/06

(52) U.S. Cl. CPC G06Q 30/0631
USPC 705/26.7

(57) ABSTRACT

The present disclosure provides example methods and apparatuses of recommending product information. When it is monitored that a user adds selected product information to a set of to-be-confirmed product information, a purchasing probability that the user purchases the selected product information is obtained. The purchasing probability may be determined according to the historical operating behavior information of the user relating to the set of to-be-confirmed product information. Recommended product information is determined in accordance with the selected product information and the purchasing probability. The recommended product information is returned to the user. The present techniques improve an effectiveness of the recommended result.

### CROSS REFERENCE TO RELATED PATENT APPLICATIONS

This application claims foreign priority to Chinese Patent Application No. 201210345774.9 filed on 17 Sep. 2012, entitled “Method and Apparatus of Recommending Product Information,” which is hereby incorporated by reference in its entirety.

### TECHNICAL FIELD

The present disclosure relates to the field of online shopping technology, and more particularly, to a method and an apparatus for recommending product information.

### BACKGROUND

With the continuous development of e-commerce, more and more users choose online shopping. A user visits a shopping website through a browser to conveniently select a product item as desired. During a process that the user browses the shopping website to select the product item, a recommending system of the shopping website plays a very important role. If a recommendation is proper, a product item that is recommended by the recommending system has a great chance of being purchased. A highly efficient recommendation system not only increases user convenience and enhances a transaction volume of the shopping website but also reduces random user browsing and clicking behaviors, thereby reducing a workload of a web server and saving network bandwidth.

During the process of browsing at the shopping website, after one product item is selected, the user may temporarily add the selected product item to a set of to-be-confirmed product information (or generally referred to as “a shopping cart”) through an interface provided by the shopping website if the user still needs to buy some other product items or is not sure whether to buy the selected product item. After multiple product items are added to the shopping cart, the user may make the payment in a batch. The user may also delete any specific product item from the shopping cart if the user later doesn't want to buy the specific product item.

A use of the shopping cart increases the convenience for the user, but the user still has to repeat the operations including browsing, searching, selecting, etc., if the user wants to select other product items after the user adds the product item to the shopping cart. In order to shorten a shopping path for the user, the recommending system of the shopping website often recommends to the user other product items according to the product item that is added in the shopping car. A recommendation result is returned and displayed at a webpage of a current product item or a webpage of the shopping cart. Thus, if the recommended product item is exactly desired by the user, the user may directly click the recommended result to redirect to a webpage of the recommended product item without other repeated operations such as browsing, searching, selecting, etc., thereby shortening the shopping path. It is apparent that an effective recommended result is crucial since an aimless recommendation causes low acceptance of the recommended result and a waste of computing resource.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides a method and an apparatus of recommending product information, which may improve an effectiveness of a recommended result.

The present disclosure provides a method of recommending product information. When a user added selected product information to a set of to-be-confirmed product information is monitored, a purchasing probability that the user purchases the selected product information is obtained. The purchasing probability may be determined according to historical operating behavior information of the user relating to the set of to-be-confirmed product information. Recommended product information is determined in accordance with the selected product information and the purchasing probability. The recommended product information is returned to the user.

For example, the purchasing probability may be determined by the following operations. A purchasing hesitation degree of the user is calculated in accordance with the historical operating behavior information of the user relating to the set of to-be-confirmed product information. The purchasing probability is calculated according to the purchasing hesitation degree of the user.

For instance, the historical operating behavior information of the user relating to the set of to-be-confirmed product information may include a number of times X that the user adds product information to the set of to-be-confirmed product information, a number of times Y that the user deletes product information from the set of to-be-confirmed product information, and a number of times Z that the user purchases product information from the set of to-be-confirmed product information. The purchasing hesitation degree is directly proportional to a sum of the number of times X and the number of times Y, and inversely proportional to the number of times Z.

For example, the step of calculating the purchasing hesitation degree of the user in accordance with the historical operating behavior information of the user relating to the set of to-be-confirmed product information may include the following. When it is monitored that the user adds the selected product information to the set of to-be-confirmed product information, the historical operating behavior information of the user relating to the set of to-be-confirmed product information is obtained and the purchasing hesitation degree of the user is calculated.

For another example, the step of calculating the purchasing hesitation degree of the user in accordance with the historical operating behavior information of the user relating to the set of to-be-confirmed product information may include the following. The historical operating behavior information of one or more users relating to the set of to-be-confirmed product information is obtained in advance. The purchasing hesitation degree of each user is calculated respectively and a calculation result is saved. When it is monitored that a current user adds the selected product information to the set of to-be-confirmed product information, the purchasing hesitation degree of the current user is obtained through inquiring the calculation result.

For another example, the step of calculating the purchasing hesitation degree of the user in accordance with the historical operating behavior information of the user relating to the set of to-be-confirmed product information may include the following. The purchasing hesitation degree of the user is calculated in accordance with all historical operating behavior information of the user relating to the set of to-be-confirmed product information.

The step of determining the purchasing probability of the user according to the purchasing hesitation degree of the user may include determining a value of function inversely proportional to the purchasing hesitation degree as the purchasing probability.

For another example, the step of calculating the purchasing hesitation degree of the user in accordance with the historical operating behavior information of the user relating to the set of to-be-confirmed product information may include the following.

The purchasing hesitation degree of the user with respect to a particular product category, to which the selected product information belongs, is obtained in accordance with the historical operating behavior information of the user relating to the particular product category in the set of to-be-confirmed product information.

The step of determining the purchasing probability of the user according to the purchasing hesitation degree of the user may include determining a value of function inversely proportional to the purchasing hesitation degree of the user with respect to the particular product category as the purchasing probability.

For another example, the step of calculating the purchasing hesitation degree of the user in accordance with the historical operating behavior information of the user relating to the set of to-be-confirmed product information may include the following.

An average purchasing hesitation degree of multiple or all users with respect to a particular product category, to which the selected product information belongs, is obtained in accordance with the historical operating behavior information of the multiple or all users relating to the set of to-be-confirmed product information under the particular product category.

The step of determining the purchasing probability of the user according to the purchasing hesitation degree of the user may include determining a value of function inversely proportional to the average purchasing hesitation degree of the multiple or all users with respect to the particular product category as the purchasing probability.

For another example, the step of calculating the purchasing hesitation degree of the user in accordance with the historical operating behavior information of the user relating to the set of to-be-confirmed product information may include the following.

The purchasing hesitation degree of the current user is calculated in accordance with all historical operating behavior information of the current user relating to the set of to-be-confirmed product information.

The purchasing hesitation degree of the current user with respect to the particular product category, to which the selected product information belongs, is obtained in accordance with the historical operating behavior information of the current user relating to the particular product category in the set of to-be-confirmed product information.

The average purchasing hesitation degree of all users with respect to the particular product category, to which the selected product information belongs, is obtained in accordance with the historical operating behavior information of all users relating to the set of to-be-confirmed product information under the particular product category.

The step of determining the purchasing probability of the user according to the purchasing hesitation degree of the user may include the following.

The value of function inversely proportional to the purchasing hesitation degree of the current user, the value of function inversely proportional to the purchasing hesitation degree of the user with respect to the particular product category, and the value of function inversely proportional to the average purchasing hesitation degree of the multiple or all users with respect to the particular product category are combined and a combined result is determined as the purchasing probability.

For instance, the value of function inversely proportional to the purchasing hesitation degree of the current user, the value of function inversely proportional to the purchasing hesitation degree of the user with respect to the particular product category, and the value of function inversely proportional to the average purchasing hesitation degree of the multiple or all users with respect to the particular product category may be combined by the following.

The value of function inversely proportional to the purchasing hesitation degree of the current user, the value of function inversely proportional to the purchasing hesitation degree of the user with respect to the particular product category, and the value of function inversely proportional to the average purchasing hesitation degree of all users with respect to the particular product category may be summed according to their respective weighted values. A result of the summing is determined as the purchase probability.

The value of function inversely proportional to the average purchasing hesitation degree of all users with respect to the particular product category may have a highest weight. The value of function inversely proportional to the purchasing hesitation degree of the user with respect to the particular product category may have a lowest weight.

For example, the step of determining recommended product information in accordance with the selected product information and the purchasing probability may include the following.

Ratios and displaying positions of related product information that is related to the selected product information and/or similar product information that is similar to the selected product information in a set of to-be-recommended product information are determined according to a value of the purchasing probability.

For instance, the larger the value of the purchasing probability is, the larger the ratio of the related product information of the selected product information to the set of to-be-recommended product information is and a higher ranking the displaying position of the related product information has. The smaller the value of the purchasing probability is, the larger the ratio of the similar product information of the selected product information to the set of to-be-recommended product information is and a higher ranking the displaying position of the similar product information has.

The present disclosure also provides an example apparatus of recommending product information. The apparatus may include a purchasing probability obtaining unit, a recommended product information unit, and a recommended product information returning unit.

The purchasing probability obtaining unit obtains a purchasing probability that a user purchases a selected product item when it is monitored that the user adds the selected product item to a set of to-be-confirmed product information. The purchasing probability may be determined according to the historical operating behavior information of the user relating to the set of to-be-confirmed product information. The recommended product information unit that determines recommended product information in accordance with the selected product information and the purchasing probability. The recommended product information returning unit returns the recommended product information to the user.

According to the example embodiments of the present disclosure, when a recommendation is required in accordance with presently selected product information that is added by a user to a set of to-be-confirmed product information, a purchasing probability that the user is to buy the selected product information is obtained. An intention of the user is accordingly analyzed to determine product information to be recommended to the user as a returning result. During this process of determining the recommended product information, as a factor of purchasing probability that the user purchases the selected product information is taken into consideration, a more accurate recommendation of product information may be achieved. Thus, a probability that the recommended result meets the user requirement is increased and an effectiveness of the recommended result is improved.

For example, in the process of obtaining the purchasing probability of the user for the selected product information, in addition to considering the purchasing hesitation degree of the user, the present techniques may also consider the purchasing hesitation degree of the user with respect to a particular product category to which the selected product item belongs. In order to avoid data sparsity, an average purchasing hesitation degree of multiple or all users with respect to the particular product category may also be considered. Alternatively, all of the above purchasing hesitation degrees may be considered.

Certainly, it is necessary for a product that employs the present techniques to have all of the above advantages at the same time.

### BRIEF DESCRIPTION OF THE DRAWINGS

To better illustrate the embodiments of the present disclosure, the following is a brief introduction of the FIGs to be used in the description of the embodiments. It is apparent that the following FIGs only relate to some embodiments of the present disclosure. A person of ordinary skill in the art can obtain other FIGs according to the FIGs in the present disclosure without creative efforts.

FIG. 1 is a flow chart of an example method of recommending product information in accordance with an example embodiment of the present disclosure.

FIG. 2 is a diagram of an example apparatus of recommending product information in accordance with the example embodiment of the present disclosure.

### DETAILED DESCRIPTION

The example embodiments will be described below with reference to the accompanying FIGs of the present disclosure. It is apparent that the example embodiments described herein do not represent all of the embodiments of the present disclosure. The other embodiments obtained by one of ordinary skill in the art based on the example embodiments of the present disclosure without creative effects shall be regarded as falling within the protective scope of the present disclosure.

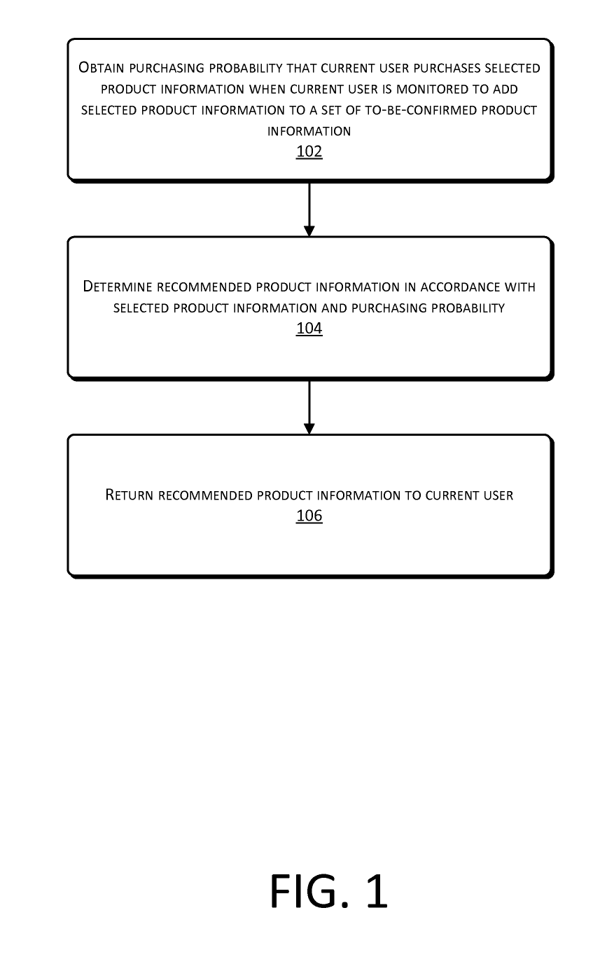

As referring to FIG. 1, the embodiment of the present disclosure provides an example method of recommending product information.

At 102, when it is monitored that a user adds selected product information to a set of to-be-confirmed product information, a purchasing probability that the user purchases the selected product information is obtained. The purchasing probability may be determined according to the historical operating behavior information of the user relating to the set of to-be-confirmed product information.

In the example embodiment of the present application, other product information is recommended to the user after the user has added selected product information to the set of to-be-confirmed product information (which may be referred to as a “shopping cart” for brevity). The recommended product information may include information of one or more other products that are related to the selected product information, which is currently added to the shopping cart. For example, if the selected product information is a mobile phone, the related product information of the selected product information may be a shell of a mobile phone, a case of a mobile phone, etc. In other words, the related product information of particular product information is generally referred to as product information of some pre-configured supporting or matching products that are generally purchased together for use together after the user purchases the particular product information.

In addition, the recommended product information may also include information of one or more other products that are similar to the selected product information which is currently added to the shopping cart. For example, if the selected product information is a mobile phone, the similar product information of the selected product information may be a mobile phone of another brand. In other words, the similar product information of the selected product information generally refers to product information that has core characteristics similar to the selected product information. For instance, the similar product information and the selected product information may belong to a same product category. There are conventional methods of obtaining the related product information of the selected product information or obtaining the similar product information of the selected product information (such as a rule of relationship, a rule of collaborative filtering, etc.) However, the conventional methods do not consider recommending whether the related product information or the similar product information, and fail to consider recommending whether more related product information or more similar product information.

However, in practical implementations, the product item that the user may continue to shop may be different in accordance with different ongoing intentions after the user adds the selected product information to the shopping car. For example, if the user proceeds to purchase the selected product information, a next shopping item may be the related product information of the selected product information, and thus more related product information will be recommended to the user in order to ensure the effectiveness of the recommendation. However, if the user still hesitates to purchase the selected product information added in the shopping cart, the next shopping item may be the product item similar to the selected product information. For example, the selected product information may be compared with other similar product information to find whether there is other product information that has higher performance-to-cost product ratio. Under such circumstances, more similar product information should be recommended to the user in order to ensure the effectiveness of the recommendation. The example embodiment of present disclosure is based on the above consideration to provide the example method of recommending information of product item. After the user adds the selected product information to the shopping cart, the present techniques do not instantly choose recommended product information to the user. Instead, the present techniques firstly determine an intention of the user. In the example embodiment of the present disclosure, the present techniques determine the intention of the user in accordance with a value of probability that the user will proceed to purchase the selected product information.

There are many implementation techniques for obtaining the purchasing probability that the user purchases the selected product information. One example method is to calculate a purchasing hesitation degree of the user in accordance with the historical operating behavior information of the user relating to the operation of the shopping cart, and to determine the purchasing probability that the user purchases the selected product information in accordance with the purchasing hesitation degree information of the user. The historical operating behavior information of the user relating to the operation of shopping cart may include: a number of times X that the user adds product information to the shopping cart, a number of times Y that the user deletes product information from the shopping cart, and a number of times Z that the user purchases product information from the shopping cart. The purchasing hesitation degree is directly proportional to a sum of the number of times X and the number of times Y, and the purchasing hesitation degree is inversely proportional to the number of times Z. For example, assuming that CUR represents the purchasing hesitation degree, it may be calculated by the following formula (1).

CUR=(X+Y)/Z (1)

In practical implementations, there may be many kinds of purchasing hesitation degrees in relation to the user. When such various purchasing hesitation degrees are calculated, the formula (1) may be applied while variables X, Y, and Z may have slightly different meanings.

For example, there is a purchasing hesitation degree of the user that is calculated in accordance with all historical operating behavior information of the user relating to the operation of the shopping cart. In other words, assuming that a current user is user A, X represents a number of times that the user A adds product information to the shopping cart, Y represents a number of times that the user A deletes product information from the shopping cart, and Z represents a number of times that the user A purchases product information from the shopping car. For instance, after the historical operating behavior information of the user is collected, it is known that the user A has added product information to the shopping cart 10 times, has deleted product information from the shopping cart 5 times, and has purchased product information from the shopping cart 5 times. Thus, the purchasing hesitation degree of the user A is (10+5)/5=3. However, if the user A has added product information to the shopping cart 10 times without ever deleting product information from the shopping cart, and has purchased product information in the shopping cart 10 times, then the purchasing hesitation degree of the user is (10+0)/10=1. In other words, if the user always likes to add product information to the shopping cart and then delete these product information from the shopping car, thereby resulting in less times of purchase, it indicates the user often does not really want to purchase product information and is used to hesitating in purchasing when the user adds product information to the shopping cart. On the contrary, if the user generally adds product information to the shopping cart and directly purchases the product information with rare deletion, it indicates the user is generally determined to make the purchase after the user adds the product information to the shopping cart.

Apparently, such information may be reflected by the calculated purchasing hesitation degrees as above. After the purchasing hesitation degree of the user is obtained, the purchasing hesitation degree of the user is used as an argument in an inverse function to obtain a value of function inversely proportional to the purchasing hesitation degree of the current user as the purchasing probability of the user to purchase the selected product information added to the shopping cart. There may be various forms of the inverse function. For example, assuming that “ACUR” represents the purchasing probability and “User CUR” represents the purchasing probability that the user purchases the presently selected product information, the inverse function may be as follows:

ACUR=K/User CUR (2)

In the formula (2), K may be a constant whose specific value may be configured in accordance with actual needs. For instance, the value of K may be 1, which means that a multiplicative inverse of the User CUR is directly used as the purchasing probability that the user purchases the selected product information presently added to the shopping cart.

In the above example method, the purchasing hesitation degree of the user is calculated by using all operations of the user relating to the shopping cart. In other words, when determining the purchasing probability that the user purchases certain selected product information, it is not necessary to determine any detail of the selected product item and the multiplicative inverse of the purchasing hesitation degree of the user is directly used as the purchasing probability. However, in practical implementations, the same user may have different purchasing hesitation degrees with respect to product information of different product categories. For example, the user generally may not have much hesitation when selecting product items under a digital product category while the user may be more hesitant when selecting product items under a clothes product category. Therefore, if the purchasing probabilities of the user with respect to product information under different product categories may be determined respectively, it may better predict the next intention of the user. Thus, more suitable product information may be recommended to the user. Accordingly, the effectiveness of recommendation is improved.

Thus, in another example embodiment, the present techniques may firstly determine the product category of the selected product information that is presently added to the shopping cart. Then, the present techniques obtain the purchasing hesitation degree of the user with respect to the product category, to which the selected product information belongs, in accordance with the historical operating behavior information of the user with respect to product items under the product category. A multiplicative inverse of the purchasing hesitation degree of the user respect to the product category may be used as a value of purchasing probability that the user purchases the selected product information.

When determining the product category of the presently selected product information, the present techniques may determine the product category according to a category of the selected product information determined by the shopping website. For example, if particular product information is selected and a category of the particular product information at the shopping website is configured as “women's apparel,” the information that may be retrieved from the historical operating behavior of the user includes: a number of times that the user adds product information belonging to the women's apparel category to the shopping cart, a number of times that the user deletes product information belonging to the women's apparel category from the shopping cart, and a number of times that the user purchases the product information belonging to the women's apparel category from the shopping cart. Then by applying the formula (1), the purchasing hesitation degree of the user with respect to the product category is calculated, and then a value of function inversely proportional to the purchasing hesitation degree with respect to the product category may be used as the purchasing probability. For instance, a multiplicative inverse of the purchasing hesitation degree of the user with respect to the product category may be used as the purchasing probability of the user for the presently selected product information.

The above example method may obtain a recommendation with a preferable result. However, in a practical implementation, the user may have few historical operating behavior information of the shopping cart with respect to a specific product category, which may cause “data sparsity” and a reference value of the calculated results may be low. The situation becomes worse if the user is at his/her first time to purchase product information under the product category as the purchasing hesitation degree of the user may be not calculated accurately. For example, the user A may shop a mobile phone, which belongs to a smart phone category, at the shopping website for his/her first time. At this situation the purchasing hesitation degree of the user with respect to the smart phone category may not be able to be calculated. In order to avoid the data sparsity, it may be preferable to obtain a parent category of the product category so that a purchasing hesitation degree of the user with respect to the patent category may be calculated. If data of the parent category is still sparse, a purchasing hesitation degree of the user with respect to a grandparent category of the parent category may be calculated, and so on.

Alternatively, in order to avoid the data sparsity problem, in one example embodiment of the present disclosure, shopping cart operating behavior of other users with respect to one specific product category may be obtained to calculate an average purchasing hesitation degree of all users with respect to the product category and its multiplicative inverse is used as the purchasing probability that the user purchases the presently selected product information. For example, for certain specific product categories, such as the clothes category, a large home appliance category, etc., purchasing hesitation degrees of all users with respect to such product categories are generally high. While for some other product categories such as a food category, purchasing hesitation degrees of all users with respect to such product categories are generally low.

From such perspective, the purchasing hesitation degrees of other users with respect to the specific product category may roughly reflect a purchasing hesitation degree of the current user with respect to the same product category. Thus, when it needs to obtain the purchasing probability of the user for the presently selected product information, the present techniques firstly determine the product category of the presently selected product information, and then obtain statistics of the historical operating behavior information of multiple or all users with respect to the product category in the shopping cart.

For example, if the presently selected product information is the mobile phone which belongs to the smart phone category, the following information may be obtained including: a total number of times that multiple or all users add the product information of the product category to the shopping cart, a total number of times that the multiple or all users delete the product information in the product category from the shopping cart, and a total number of times that the multiple or all users purchase the product information of the product category from the shopping cart. These variables are then introduced to the formula (1) to calculate the average purchasing hesitation degree of the multiple or all users with respect to the product category and a value of function inversely proportional to the average purchasing hesitation degree may be used as a purchasing probability. For example, a multiplicative inverse of the average purchasing hesitation degree may be used as the purchasing probability of the current user with respect to the selected product information.

In the above example methods, the purchasing hesitation degree of the user, the purchasing hesitation degree of the user with respect to the product category, to which the present product information belongs, and the average purchasing hesitation degree of the multiple or all users with respect to the product category, to which the present product information belongs, are calculated respectively, and then the respective value of function inversely proportional to each of the purchasing hesitation degree is respectively used as a purchasing probability of the user that purchases the present product information.

In some other implementation, all of the above purchasing hesitation degrees may be considered. For example, a combination of the values of function inversely proportional to the above purchasing hesitation degrees is processed to obtain a combined result. The combined result is determined as the purchasing probability of the user that purchases the selected product information.

There are many ways for such combination. For example, the combined result may be obtained by multiplying a coefficient with each of the values of functions inversely proportional to the above purchasing hesitation degrees. Alternatively, a sum of weighted values of functions inversely proportional to the above purchasing hesitation degrees may be obtained as a weighted result and the weighted result is used as the purchasing probability that the user purchases the present product information. For example, assuming the value of function inversely proportional to the purchasing hesitation degree of the user is called “User ACUR,” the value of function inversely proportional to the purchasing hesitation degree of the user with respect to the product category, to which the present product information belongs, is called “User Category ACUR,” and the value of function inversely proportional to the average purchasing hesitation degree of multiple or all users with respect to the product category, to which the present product information belongs, is called “Category ACUR”, then the comprehensive purchasing hesitation degree of the user may be represented by using the following formula (3):

comprehensive purchasing hesitation degree=(K*Category ACUR+M*User Category ACUR+L*User ACUR)/3 (3)

The corresponding weights of the various purchasing hesitation degrees may be adjusted in accordance with different situations. For example, the value of function inversely proportional to the average purchasing hesitation degree of multiple or all users with respect to the product category, i.e. Category ACUR, may have a highest weight. The value of function inversely proportional to the purchasing hesitation degree of the user with respect to the product category, i.e. User Category ACUR, may have a lowest weight. The value of function inversely proportional to the purchasing hesitation degree of the user may have a weight between the highest weight and the lowest weight. In other words, in formula (3), the coefficients K, M, and L correspond to the weight of the Category ACUR, the User Category ACUR, and the User ACUR respectively, and have the following relationship: K>L>M.

It should be noted that the operations of calculating the value of the purchasing hesitation degrees may be executed instantly while the purchasing probability that the user purchases the present selected product information needs to be obtained. Alternatively, in another implementation, the operations of calculating may be pre-executed. When there is a need to obtain the purchasing probability that the user purchases the present selected product information, the pre-calculated results may be searched or inquired to find a matching result. No matter whether it is an instant calculation or a pre-calculation, the detailed calculating methods may be the same or substantially the same. However, there might be a slight difference. As the presently selected product information has been known, when the purchasing hesitation degree based on the product category is calculated, only the purchasing hesitation degree of the product category, to which the presently selected product information belongs, is calculated. In the case of the pre-calculation method, as the product information to be selected by the user is unknown, it may be required to calculate the purchasing hesitation degree with respect to each product category. When there is the need to obtain the purchasing probability that the user purchases certain selected product information, the purchasing hesitation degree with respect to the category, to which the selected product information belongs, is searched or inquired from the calculation result. The purchasing hesitation degree based on the category may include the purchasing hesitation degree of the user with respect to the product category and the average purchasing hesitation degree of multiple or all users with respect to the product category.

Moreover, with respect to obtaining the historical operating behavior information of the user relating to operation of the shopping cart, as a server of the shopping website is capable to record the historical operating behavior information relating to the operation of shopping cart for each user, the operation of choosing recommended product information for the users may be accomplished at the server. Thus, the required historical operating behavior information of the user may be obtained in accordance with records at the server-end of the shopping website.

At 104, recommended product information is determined in accordance with the selected product information and the purchasing probability.

After the purchasing probability that the current user purchases the presently selected product information is obtained, the next intention of the user is analyzed in accordance with the value of the purchasing probability. In other words, a percentage of related product information of the selected product information and similar product information of the selected product information in the set of to-be-recommended product information is determined and their displaying positions are also determined. For example, a threshold value is preset. If the purchasing probability that the current user purchases the presently selected product information is higher than the threshold value, it indicates that the user may purchase the product information, and thus the related product information of the selected product information is recommended to the user. However, if the purchasing probability that the current user purchases the presently selected product information for the user is smaller than the threshold value, it indicates that the user may still need to compare other similar product items, and thus the similar product information of the selected product information is recommended to the user. Alternatively, instead of two classifications, the intention of the user may be classified into multiple probability intervals. Each probability interval corresponds to different percentages of the related product information and the similar product information. When it is found that the purchasing probability that the user purchases the presently selected product information is within a specific interval, recommended product information is determined according to the percentage corresponding to the specific interval.

In general, the higher the value of the purchasing probability that the user purchases the presently selected product information is, the higher the percentage of the related product information of the selected product information in the set of recommended product information and the higher rankings of their displaying position have, while the smaller the percentage of the similar product information of the selected product information in the set of recommended product information is and the lower rankings of their displaying positions have. The smaller the value of the purchasing probability that the user purchases the presently selected product information is, the higher the percentage of the similar product information of the selected product information in the set of recommended product information and the higher rankings of their displaying position have, while the smaller the percentage of the related product information of the selected product information in the set of recommended product information is and the lower rankings of their displaying positions have.

At 106, the recommended product information is returned to the user.

After the recommended product information is determined, the recommended product information is sent and returned to the user. For example, the recommended product information may be returned to the webpage of the shopping cart in a form of a list. When the recommended product information is returned, if the recommended product information includes not only the related product information of the presently selected product information but also the similar product information of the presently selected product information, it may require a division of their displaying positions. The recommended product information determined according to the step of 104 is returned according to their displaying positions.

In summary, in the example embodiment of present disclosure, when the present techniques recommend product information in accordance with the presently selected product information that is added to the set of to-be-confirmed product information, the present techniques firstly need to obtain the purchasing probability that the user purchases the presently selected product information so as to analyze the intention of the user to determine the product information to be recommended to the user and to be returned. In this process, as a factor of purchasing probability that the user purchases the presently selected product information is taken into consideration for the recommended product information, the present techniques may more accurately recommend product information, thereby obtaining a high probability that the recommended result meets the user needs and improving an effectiveness of the recommended result.

In some example embodiments, while in the process of obtaining the purchasing probability that the user purchases the presently selected product information, in addition to considering the purchasing hesitation degree of the user, the purchasing hesitation degree of the user with respect to the product category, to which the presently selected product information belongs, may also be considered. In order to avoid the data sparsity problem, a further consideration of an average purchasing hesitation degree of multiple or all users with respect to the product category, to which the presently selected product information belongs, may also be considered. Alternatively, the above various purchasing hesitation degrees may be comprehensively considered.

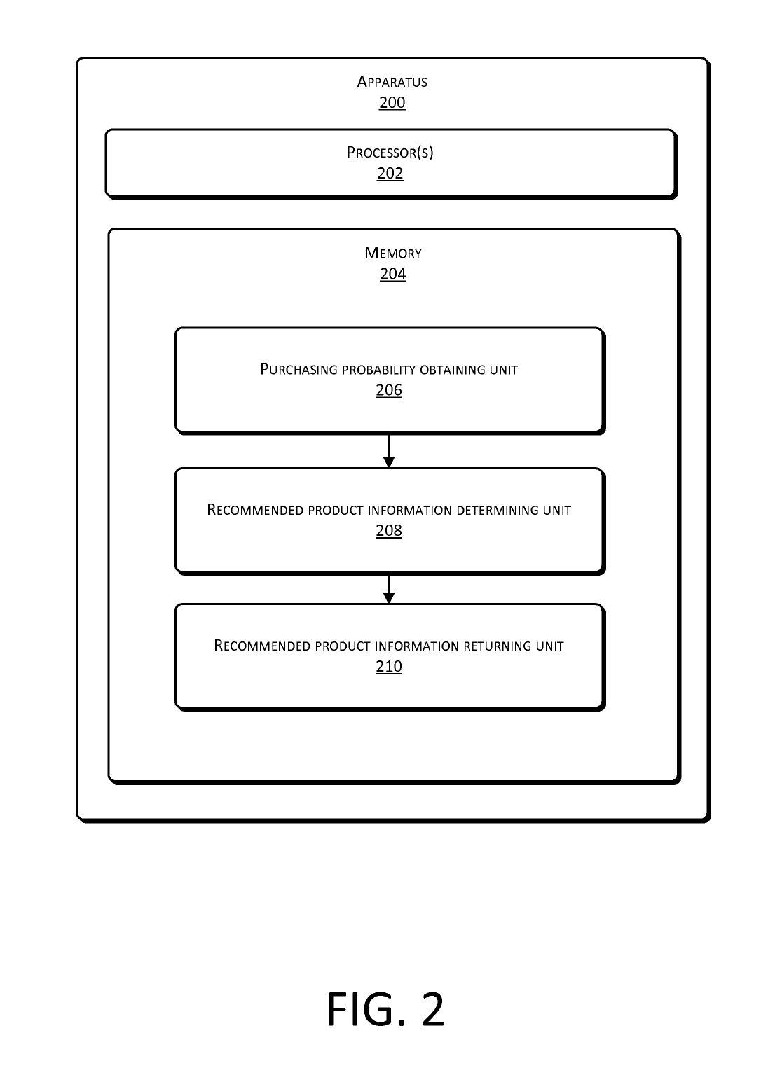

Corresponding to the example method of recommending product information as disclosed by the present disclosure, by reference to FIG. 2, the present disclosure also provides an example apparatus 200 of recommending product information. The apparatus 200 may include one or more processor(s) 202 and memory 204. The memory 204 is an example of computer-readable media. As used herein, “computer-readable media” includes computer storage media and communication media.

Computer storage media includes volatile and non-volatile, removable and non-removable media implemented in any method or technology for storage of information such as computer-executed instructions, data structures, program modules, or other data. In contrast, communication media may embody computer-readable instructions, data structures, program modules, or other data in a modulated data signal, such as a carrier wave. As defined herein, computer storage media does not include communication media. The memory 204 may store therein program units or modules and program data.

In the example of FIG. 2, the memory 204 may store therein a purchasing probability obtaining unit 206, a recommended product information determining unit 208, and a recommended product information returning unit 210.

The purchasing probability obtaining unit 206 obtains a purchasing probability that a user purchases a selected product item when it is monitored that the user adds selected product item information to a set of to-be-confirmed product information. The purchasing probability may be determined according to the historical operating behavior information of the user relating to the set of to-be-confirmed product information.

The recommended product information unit 208 determines recommended product information in accordance with the selected product information and the purchasing probability. The recommended product information returning unit 210 returns the recommended product information to the user.

For example, the purchasing probability may be determined by the following units. In other words, the purchasing probability obtaining unit 206 may include the following units.

A purchasing hesitation degree calculating unit calculates a purchasing hesitation degree of the user according to the historical operating behavior information of the user relating to the set of to-be-confirmed product information. A purchasing probability determining unit determines the purchasing probability in accordance with the purchasing hesitation degree of the user.

The historical operating behavior information of the user relating to the set of to-be-confirmed product information may include the following: a number of times X that the user adds product information to the set of to-be-confirmed product information, a number of times Y that the user deletes product information from the set of to-be-confirmed product information, and a number of times Z that the user purchases product information from the set of to-be-confirmed product information. The purchasing hesitation degree is directly proportional to a sum of the number of times X and the number of times Y, and inversely proportional to the number of times Z.

For example, the purchasing hesitation degree may be calculated instantly or pre-calculated. In the example that the purchasing probability is calculated instantly, the purchasing hesitation degree calculating unit may include an instant calculating sub-unit.

The instant calculating sub-unit, when the user is monitored to add the selected product information to the set of to-be-confirmed product information, obtains the historical operating behavior information of the user relating to the set of to-be-confirmed product information and calculates the purchasing hesitation degree of the user.

In the example that the purchasing hesitation degree is pre-calculated, the purchasing hesitation degree calculating unit may include a pre-calculating sub-unit and an inquiring unit. The pre-calculating sub-unit obtains the historical operating behavior information of one or more users relating to the set of to-be-confirmed product information in advance, calculates a purchasing hesitation degree of each user respectively, and saves the calculated results.

The inquiring sub-unit obtains the purchasing hesitation degree of the current user by inquiring the calculated results when it is monitored that the current user adds the selected product information to the set of to-be-confirmed product information.

There are various methods of calculating the purchasing hesitation degree of the user. For example, the purchasing hesitation degree calculating unit may include a user purchasing hesitation degree calculating sub-unit that calculates the purchasing hesitation degree of the user in accordance with all historical operating behavior information of the user relating to the set of to-be-confirmed product information. The purchasing probability determining unit may include a first determining sub-unit that determines the purchasing probability according to a value of function inversely proportional to the purchasing hesitation degree of the user.

For another example, the purchasing probability obtaining unit may include a user category purchasing hesitation degree calculating sub-unit that obtains a purchasing hesitation degree of the user with respect to a product category, to which the selected product information belongs, in accordance with historical operating behavior information of the user relating to the product category, to which the selected product information belongs, in the set of to-be-confirmed product information. The purchasing probability determining unit may include a second determining sub-unit that determines the purchasing probability according to a value of function inversely proportional to the purchasing hesitation degree of the user with respect to the product category.

For another example, the purchasing probability obtaining unit may include a category purchasing hesitation degree calculating sub-unit that obtains an average purchasing hesitation degree of multiple or all users with respect to a product category, to which the selected product information belongs, in accordance with historical operating behavior information of the multiple or all users relating to the product category, to which the selected product information belongs, in the set of to-be-confirmed product information. The purchasing probability determining unit may include a third determining sub-unit that determines the purchasing probability according to a value of function inversely proportional to the average purchasing hesitation degree of the multiple or all users with respect to the product category.

Alternatively, the above various purchasing hesitation degrees may be comprehensively considered. The purchasing hesitation degree calculation unit may include the user purchasing hesitation degree sub-unit, the user category purchasing hesitation degree calculating sub-unit, and the category purchasing hesitation degree calculating sub-unit.

The user purchasing hesitation degree calculating sub-unit calculates the purchasing hesitation degree of the user in accordance with all historical operating behavior information of the user relating to the set of to-be-confirmed product information.

The user category purchasing hesitation degree calculating sub-unit that obtains a purchasing hesitation degree of the user with respect to a product category, to which the selected product information belongs, in accordance with historical operating behavior information of the user relating to the product category, to which the selected product information belongs, in the set of to-be-confirmed product information.

The category purchasing hesitation degree calculating sub-unit that obtains an average purchasing hesitation degree of multiple all users with respect to a product category, to which the selected product information belongs, in accordance with historical operating behavior information of the multiple or all users relating to the product category, to which the selected product information belongs, in the set of to-be-confirmed product information.

The purchasing probability determining unit may include a fourth determining sub-unit that combines the value of function inversely proportional to the purchasing hesitation degree of the user, the value of function inversely proportional to the purchasing hesitation degree of the user with respect to the product category, and the value of function inversely proportional to the average purchasing hesitation degree of the multiple or all users with respect to the product category to obtain a combined result and determine the purchasing probability according to the combined result.

The value of function inversely proportional to the purchasing hesitation degree of the current user, the value of function inversely proportional to the purchasing hesitation degree of the user with respect to the product category, and the value of function inversely proportional to the average purchasing hesitation degree of the multiple or all users with respect to the product category may be summed according to their respective weights. A result of the summing is determined as the purchase probability.

The value of function inversely proportional to the average purchasing hesitation degree of all users with respect to the product category may have a highest weight. The value of function inversely proportional to the purchasing hesitation degree of the user with respect to the particular product category may have a lowest weight.

For example, the recommended product information determining unit 208 may determine ratios and displaying positions of related product information that is related to the selected product and similar product information that is similar to the selected product in the set of to-be-recommended product information according to the value of the purchasing probability.

For instance, the larger the value of the purchasing probability is, the larger the ratio of the related product information of the selected product information to the set of to-be-recommended product information is and a higher ranking the displaying position of the related product information has.

Under the present techniques, when a recommendation is required in accordance with the presently selected product information that is added by the user to the set of to-be-confirmed product information, the purchasing probability that the user is to buy the selected product information is obtained. An intention of the user is accordingly analyzed to determine product information to be recommended to the user as a returning result. During this process of determining the recommended product information, as a factor of purchasing probability of the selected product information of the user is taken into consideration, a more accurate recommendation of product information may be achieved. Thus, a probability that the recommended result meets the user requirement is increased and an effectiveness of the recommended result is improved.

In some example embodiments, in the process of obtaining the purchasing probability of the user for the selected product information, in addition to considering the purchasing hesitation degree of the user, the present techniques may also consider the purchasing hesitation degree of the user with respect to a particular product category to which the selected product item belongs. In order to avoid data sparsity, an average purchasing hesitation degree of multiple or all users with respect to the particular product category may also be considered. Alternatively, all of the above purchasing hesitation degrees may be considered.

According to the above example embodiments, one of ordinary skill in the art would understand that the present techniques may be implemented by hardware, software, or a combination of software and necessary universal hardware platform. Thus, the present techniques may be in the form of software products. The software products may be stored in computer storage media such as ROM/RAM, disk, CD-ROM, etc, that contains computer-executable instructions executable by one or more computer devices (such as a personal computer, a server, or a network device) to perform methods or operations as described in the various embodiments or part of the embodiments of the present disclosure.

The example embodiments of the present invention are described progressively. The same and similar portions among the various embodiments may be referred to each other. Each example embodiment emphasizes its differences from the other example embodiments. Especially, the descriptions of the apparatus or system example embodiment of the present invention are relatively brief as their implemented operations are generally similar to those in the example method embodiments. The relevant portions may be referenced to those in the example method embodiments. The above described apparatus or system example embodiments are merely for illustration purpose. The separately describes units may be or may be not physically separable. The returning units may be or may be not physical units. In other words, the units may locate at one location or distributed in the network as several network units. Some or all module may be selected based on the actual needs to implement the present techniques. One of ordinary skill in the art may understand and implement the present techniques without any other extra creative efforts.

The above descriptions illustrate example methods and apparatuses of recommending product information in accordance with the present disclosure. The present disclosure uses example embodiments to illustrate the example principles and implementations of the present disclosure. The above example embodiments simply help understand the example methods and ideas of the present disclosure. It should be understood by one of ordinary skill in the art that certain modifications, replacements, and improvements may be made and should still be considered under the protection of the present disclosure without departing from the principles of the present disclosure. The present specification shall not be a limitation of the present techniques.

What is claimed is:

1. A method comprising:
monitoring that a user adds selected product information to a set of to-be-confirmed product information,
obtaining a purchasing probability that the user purchases the selected product information; and
determining recommending product information in accordance with the selected product information and the purchasing probability.

2. The method as recited in claim 1, wherein the set of to-be-confirmed product information is a shopping cart at a website.

3. The method as recited in claim 1, further comprising returning the recommended product information to the user.

4. The method as recited in claim 1, wherein the obtaining the purchasing probability comprises determining the purchasing probability according to historical operating behavior information of the user relating to the set of to-be-confirmed product information.

5. The method as recited in claim 1, wherein the obtaining the purchasing probability comprises:
obtaining a purchasing hesitation degree of the user in accordance with historical operating behavior information of the user relating to the set of to-be-confirmed product information; and
determining the purchasing probability according to the purchasing hesitation degree of the user.

6. The method as recited in claim 5, wherein the historical operating behavior information of the user relating to the set of to-be-confirmed product information comprises:
a number of times X that the user adds product information to the set of to-be-confirmed product information;
a number of times Y that the user deletes product information from the set of to-be-confirmed product information; and
a number of times Z that the user purchases product information from the set of to-be-confirmed product information.

7. The method as recited in claim 6, wherein the purchasing hesitation degree is proportional to a sum of the number of times X and the number of times Y, and inversely proportional to the number of times Z.

8. The method as recited in claim 5, wherein the determining the purchasing probability according to the purchasing hesitation degree of the user comprises using a value of function inversely proportional to the purchasing hesitation degree as the purchasing probability.

9. The method as recited in claim 1, wherein the obtaining the purchasing probability comprises:
obtaining a purchasing hesitation degree of the user with respect to a particular product category, to which the selected product information belongs, in accordance with historical operating behavior information of the user relating to the particular product category in the set of to-be-confirmed product information; and
determining the purchasing probability according to the purchasing hesitation degree of the user with respect to the particular product category.

10. The method as recited in claim 1, wherein the obtaining the purchasing probability comprises:
obtaining an average purchasing hesitation degree of multiple users with respect to a particular product category, to which the selected product information belongs, in accordance with historical operating behavior information of the multiple users relating to the particular product category in the set of to-be-confirmed product information; and
determining the purchasing probability according to the average purchasing hesitation degree of multiple users with respect to the particular product category.

11. The method as recited in claim 1, wherein the obtaining the purchasing probability comprises:
obtaining a purchasing hesitation degree of the user in accordance with historical operating behavior information of the user relating to the set of to-be-confirmed product information;
obtaining a purchasing hesitation degree of the user with respect to a particular product category, to which the selected product information belongs, in accordance with historical operating behavior information of the user relating to the particular product category in the set of to-be-confirmed product information;
obtaining an average purchasing hesitation degree of multiple users with respect to the particular product category in accordance with historical operating behavior information of the multiple users relating to the particular product category in the set of to-be-confirmed product information; and
determining the purchasing probability according to the purchasing hesitation degree of the user, the purchasing hesitation degree of the user with respect to the particular product category, and the average purchasing hesitation degree of the multiple users with respect to the particular product category.

12. The method as recited in claim 11, wherein the determining the purchasing probability according to the purchasing hesitation degree of the user, the purchasing hesitation degree of the user with respect to the particular product category, and the average purchasing hesitation degree of multiple users with respect to the particular product category comprises:
combining a value of function inversely proportional to the purchasing hesitation degree of the user, a value of function inversely proportional to the purchasing hesitation degree of the user with respect to the particular product category, and a value of function inversely proportional to the average purchasing hesitation degree of the multiple users with respect to the particular product category; and
using a combined result as the purchasing probability.

13. The method as recited in claim 12, wherein the combining the value of function inversely proportional to the purchasing hesitation degree of the user, the value of function inversely proportional to the purchasing hesitation degree of the user with respect to the particular product category, and the value of function inversely proportional to the average purchasing hesitation degree of multiple users with respect to the particular product category comprises:
pre-setting a weight of the value of function inversely proportional to the purchasing hesitation degree of the user, a weight of the value of function inversely proportional to the purchasing hesitation degree of the user with respect to the particular product category, and a weight of the value of function inversely proportional to the average purchasing hesitation degree of the multiple users with respect to the particular product category; and
adding the value of function inversely proportional to the purchasing hesitation degree of the user, the value of function inversely proportional to the purchasing hesitation degree of the user with respect to the particular product category, and the value of function inversely proportional to the average purchasing hesitation degree of multiple users with respect to the particular product category according to their respective weights.

14. The method as recited in claim 13, wherein the weight of the value of function inversely proportional to the average purchasing hesitation degree of multiple users with respect to the particular product category is highest among the respective weights.

15. The method as recited in claim 13, wherein the weight of the value of function inversely proportional to the purchasing hesitation degree of the user with respect to the particular product category is lowest among the respective weights.

16. The method as recited in claim 1, wherein the determining recommending product information in accordance with the selected product information and the purchasing probability comprises:
determining ratios of related product information that is related to the selected product information and similar product information that is similar to the selected product information in a set of to-be-recommended product information according to a value of the purchasing probability, a higher value of the purchasing probability corresponding to a larger ratio of the related product information in the set of to-be-confirmed product information.

17. The method as recited in claim 1, wherein the determining recommending product information in accordance with the selected product information and the purchasing probability comprises:
determining one or more displaying positions of related product information that is related to the selected product information and similar product information that is similar to the selected product information in a set of to-be-recommended product information according to a value of the purchasing probability, a higher value of the purchasing probability corresponding to a higher ranking of the related product information in the set of to-be-confirmed product information.

18. The method as recited in claim 1, wherein the obtaining the purchasing probability that the user purchases the selected product information comprises:
obtaining historical operating behavior information of multiple users relating to the set of to-be-confirmed product information in advance;
calculating purchasing hesitation degrees of the multiple users in accordance with the historical operating behavior information of the multiple users relating to the set of to-be-confirmed product information respectively;
saving a result of the calculating; and
when monitoring that the user adds selected product information to the set of to-be-confirmed product information, obtaining a purchasing hesitation degree of the user through inquiring the result of the calculating.

19. An apparatus comprising:
a purchasing probability obtaining unit that obtains a purchasing probability that a user purchases selected product information when the user is monitored to add the selected product information to a set of to-be-confirmed product information and determines a purchasing probability that the user purchases the selected product information according to historical operating behavior information of the user relating to the set of to-be-confirmed product information;
a recommended product information unit that determines recommended product information in accordance with the selected product information and the purchasing probability; and
a recommended product information returning unit that returns the recommended product information to the user.

20. One or more computer storage media stored therein computer-executable instructions that are executable by one or more computing devices to perform operations comprising:
monitoring that a user adds selected product information to a set of to-be-confirmed product information,
obtaining a purchasing probability that the user purchases the selected product information; and
determining recommending product information in accordance with the selected product information and the purchasing probability.
